(19) United States
(12) Patent Application Publication
(10) Pub. No.: US 2003/0021275 A1
(43) Pub. Date: Jan. 30, 2003

(54) Mobile data routing

(76) Inventor: Mohammed Shabeer, Ipswich (GB)

Correspondence Address: Nixon & Vanderhye, 8th Floor, 1100 North Glebe Road, Arlington, VA, 22201-4714, US

(21) Appl. No.: 10/220,856

(22) PCT Filed: Mar. 7, 2001
(86) PCT No.: PCT/GB01/00993

(30) Foreign Application Priority Data
Mar. 31, 2000 (EP) 00302743.0

(51) Int. Cl. H04L 12/28

(52) U.S. Cl. 370/393

(57) ABSTRACT

The present invention relates to the routing of data within communications networks, including but not confined to networks such as the Internet, and particularly, but not exclusively, to a method of routing data directed to a mobile node.

In this invention a protocol is provided which is backward compatible with Mobile IP and Mobile IP with route optimisation. The new protocol uses existing defined messages, utilising unused bits to overcome the problems of triangular routing and tunnelling.

The present invention relates to the routing of data within communications networks, including but not confined to networks such as the Internet, and particularly, but not exclusively, to a method of routing data directed to a mobile node. The mobile node may be a mobile host, such as a portable computer, or it may be a router which is responsible for the mobility of one or more entire networks, for example, the mobile data network within an aircraft. In either case, the mobile node may change its point of attachment from one network or sub-network to another.

The routing of data around the diverse networks which make up the Internet is based on a protocol known as the Internet Protocol (IP). Data is transferred in the form of data units known as IP datagrams between points in the Internet specified by IP addresses. The use of IP hides the physical nature of the underlying networks from application processes running over the Internet. These networks may, for example, be a combination of wired and wireless local and wide area networks using different physical protocols such as Ethernet and token-ring, including networks linked by telephone through an Internet Service Provider (ISP), or through satellite or ground based radio or infra-red links.

The detailed specification of IP is available in a “Request for Comments” document, RFC 791, maintained by the Internet Engineering Task Force (IETF). RFC documents are widely available on the Internet at, for example, “ftp://ds.internic.net/rfc/rfcxxxx.txt”, where “xxxx” represents the RFC number, so that RFC 791 is available as rfc791.txt.

The current version of IP, known as IPv4, does not itself support mobility, but a protocol entitled “IP Mobility Support”, commonly referred to in this description as Mobile IP, has been designed to enhance IPv4 to support mobility. This protocol is described in document RFC 2002, available as detailed above. The next generation of IP (IPv6) is being designed to deal with the mobility requirement.

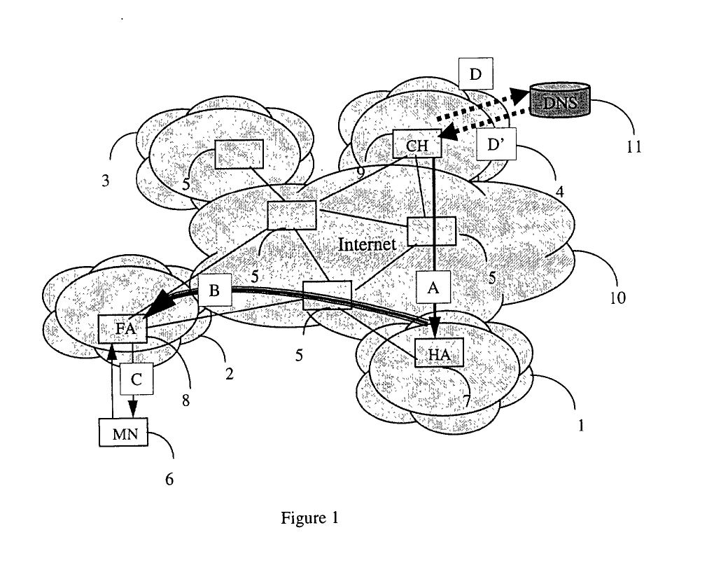

IPv4 assumes that a node's IP address uniquely identifies the node's fixed point of attachment to the Internet. If the node is transferred to a different point, it can only be contacted by allocating it a new IP address. Mobile IP, however, enables a mobile node, such as a laptop or palmtop computer, to send and receive IP datagrams over the Internet regardless of the physical location at which it is connected to the Internet and without changing its IP address. One example of the mechanism by which it does so is illustrated in FIG. 1.

The Internet comprises a large number of networks and sub-networks 1, 2, 3, 4 connected via routers 5. A router may be a general purpose computer programmed to perform routing tasks. Increasingly, routers throughout the Internet are dedicated pieces of hardware, controlled by software or firmware, provided by companies such as Cisco Systems, California, USA.

A mobile node (MN) 6 is normally connected to the Internet via a home network 1. The unique IP address assigned to the node 6 is known as its home address. Mobility agents, known as foreign agents (FA) and home agents (HA), advertise their presence on a network via availability messages known as Agent Advertisements. A mobility agent is typically a router connected to a particular network; for example, a home agent 7 is a router connected to the home network 1 and a foreign agent 8 is a router connected to a foreign network 2. The mobile node 6 may optionally solicit an Agent Advertisement message from any local mobility agents via an Agent Solicitation message. By receiving Agent Advertisements, the mobile node 6 is able to determine whether it is on its home network 1 or on a foreign network 2, 3, 4.

While the mobile node 6 is on its home network, it has no need for mobility services. When the mobile node 6 is temporarily moved to a foreign network 2 it obtains a temporary care-of address on the foreign network 2. This can be a foreign agent care-of address, which is the IP address of the foreign agent, obtained by receiving or soliciting Agent Advertisements from any foreign agents based on the foreign network 2. Alternatively, the care-of address may be obtained by using an external assignment mechanism, such as Dynamic Host Configuration Protocol (DHCP) (the reader is referred to RFC 1541 for further information), in which case it is known as a co-located care-of address.

The mobile node 6 then registers its new care-of address with its home agent 7 by exchanging Registration Request and Registration Reply messages with it. Registration provides a mechanism by which mobile nodes can communicate their current reachability information to their home agent. The registration process is described in more detail below, assuming that the mobile node 6 on the foreign network 2 is registering a foreign agent care-of address received via an Agent Advertisement from, for example, foreign agent 8.

First, the mobile node 6 sends a Registration Request message to the foreign agent 8, which processes it and forwards it to the mobile node's home agent 7. The Registration Request message includes the IP address of the foreign agent. The home agent 7 sends a Registration Reply message to the foreign agent 8 granting (or denying) the registration request. The foreign agent 8 processes this Reply and forwards it to the mobile node 6. This process establishes a temporary address for the mobile node 6 to which datagrams can be delivered while the node is roaming away from its home network 1.

If the mobile node 6 is returning to its home network 1 having been on a foreign network 2, it deregisters with its home agent 7, as specified in the IETF RFC 2002 (C. Perkins. IP Mobility Support. Request for Comments (Proposed Standard) 2002, Internet Engineering Task Force, October 1996.

When a correspondent node (CN) 9 attached to a network 4 is required by an application running on the node 9 to send a message intended for the mobile node 6 the correspondent node must first determine the address of node 6. The correspondent node performs domain name server (DNS) lookup as described in “Internet system Handbook”, Daniel C. Lynch and Marshall T. Rose, Addison Wesley Publishing Company, 1993 and RFC 1123 by sending a message to a domain name server 11 indicated by arrows D and D′ in FIG. 1. DNS lookup provides the permanent (or home) IP address of the mobile node 6. As mentioned previously this IP address uniquely identifies a fixed point of attachment to the Internet. The IP address thus obtained is then used by that application for the duration of the session or until the lifetime expiry as will be explained later.

When the correspondent node 9 sends the datagram intended for the mobile node 6, while the mobile node is connected to the foreign network 2, the datagram is intercepted by the home agent 7, as shown by arrow A. The home agent 7 encapsulates the datagrams forming the message with the care-of address for the mobile node 6, in this example being the IP address of the foreign agent 8, and forwards the message to the foreign agent 8. The transmission of the encapsulated datagrams, shown by arrow B, is known as tunnelling. The foreign agent 8 receives the datagrams, decapsulates them and forwards them to the mobile node 6, as shown by arrow C. A common misconception is that messages from the mobile node 6 to other nodes in the Internet need not follow this route, but may be sent directly via an appropriate router, which may be foreign agent 8. However, ‘firewalls’ in the routers prevent transmission of datagrams which do not appear to originate from the network to which the router is connected. Therefore it is necessary for messages from the mobile node 6 to be intercepted by the foreign agent 8. The foreign agent 8 then encapsulates the datagrams before sending them. Datagrams from the MN to the CN are routed in accordance the specification of IETF RFC 2002 or alternatively using reverse tunneling as specified in the IETF RFC 2344.

The concepts of encapsulation and tunnelling are described in detail in IETF RFC 2003, “IP Encapsulation within IP”. The model is that a tunnel is the path followed by a datagram while encapsulated. Encapsulation allows an IP datagram to be hidden from intermediate routers which would incorrectly attempt to route it to the mobile node. Instead, the datagram is routed between the encapsulator and a knowledgeable decapsulator, such as a foreign agent, which can correctly route the datagram. The home agent 7 and foreign agent 8 are known as the endpoints of the tunnel. In the case of the co-located care-of address, the mobile node itself acts as an endpoint of the tunnel.

To enable the tunnelling process described above to function correctly, the home agent 7 maintains reachability information for the mobile node 6, in a form known as a mobility binding. This is the association of the mobile node's identity with a care-of address and a parameter known as the Lifetime, which is the number of seconds remaining before the registration of the node 6 with the home agent 7 expires. The aim behind a Lifetime value is to maintain the dynamic nature of the system, with a binding expiring within a set time unless positively maintained by the mobile node 6. As an example, the default Router Advertisement Lifetime value, which may be used where a mobile node is registering with a foreign agent which it has acquired via an Agent Advertisement, is 1800 seconds.

On receipt of a Registration Request message, the home agent 7 creates or modifies the mobility binding, for example, by re-setting the Lifetime value where the Request is a re-registration request and the mobility binding has not yet expired. If the Lifetime value for a given mobility binding expires before a re-registration request has been received, the home agent 7 deletes the mobility binding from its record. The Registration Reply message from the home agent 7 informs the mobile node 6 (via the foreign agent 8) of the status of its Request, including the Lifetime value allocated by the home agent 7.

The simplified description of Mobile IP is used only to highlight the main features relevant to the description of current invention, however, for additional details interested readers should refer to the relevant reference (i.e. RFC 2002). The non-optimal routing introduced as a result of this protocol is referred to as triangular routing which is defined a situation in which datagrams follow a path which is longer than the optimal path

In order to avoid the problem of triangular routing, route optimisation techniques have been devised, for example, as described in Internet Engineering Task Force (IETF) Draft “Route Optimization in Mobile IP” which may be found at URL: http://www.ietf.org/internet-drafts/draft-ietf-mobileip-optim-09.txt.

This route optimisation technique provides a means for nodes to cache the mobility binding of a mobile node and to then tunnel their own datagrams directly to the care-of address indicated in that binding, bypassing the mobile node's home agent. When sending an IP datagram to a mobile node, if the sender has a binding cache entry for the destination mobile node, it may tunnel the datagram directly to the care-of address indicated in the cached mobility binding.

The protocol also allows datagrams in flight when a mobile node moves, and datagrams sent based on an out-of-date cached binding, to be forwarded directly to the mobile node's new care-of address.

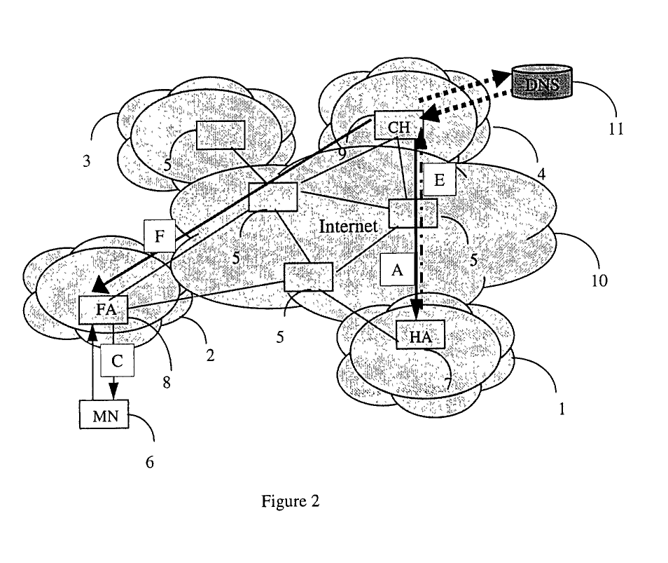

An example of routing using route optimisation will now be described with reference to FIG. 2. Again as for Mobile IP, only a brief description of Mobile IP with route optimisation is described and interested readers should refer to the IETF draft (i.e http://www.ietf.org/internet-drafts/draft-ietf-mobileip-optim-09.txt). The mobile node 6 obtains a care-of address and registers this with the home agent 7 as described previously. Initially datagrams sent by the correspondent node 9 are intercepted by the home agent 7, encapsulated and tunnelled to the foreign agent 8 as described with reference to Mobile IP.

When the home agent 7 intercepts such a datagram the home agent 7 deduces that the correspondent node 9 has no binding cache entry for the destination mobile node 6. The home agent 7 sends a Binding Update message to the correspondent node as shown by arrow E, informing it of the mobile node's current mobility binding. No acknowledgement for the the Binding Update message is needed, since additional future datagrams from the correspondent node intercepted by the home agent for the mobile node will cause transmission of another Binding Update. The correspondent node 9 creates a binding cache entry for the mobile node 6, and tunnels future datagrams directly to the mobile node 6 as indicated by arrow F.

However, if the MN registration has a private bit known as the ‘p’ bit set then the GHA does not send the binding update message to the correspondent node. Of course in this case Mobile IP with direct routing cannot be used, just as Mobile IP with route optimisation cannot be used either.

As before, each binding in a binding cache also has an associated lifetime, specified in the Binding Update message in which the node obtained the binding. After the expiration of this time period, the binding must be deleted from the cache.

The problem with this approach is that although triangular routing has been eliminated the datagrams are still encapsulated and tunnelled to the mobile node. Thus the bandwidth and protocol overhead associated with encapsulation of the datagrams is still present. Furthermore there are other problems with tunneling and QoS related protocols (such as RSVP as described in Internet Draft “Resource ReSerVation Protocol”—Version 1 Functional Specification” Internet draft draft-ietf-rsvp-spec16.txt).

According to the present invention there is provided a method of allocating a network address for an application to use during a session between a first node in a domain and a mobile node in a visited domain, said method comprising the steps of allocating a care-of address to the mobile node; registering the allocated care-of address with a global home agent associated with the mobile node; the global home agent informing the first node of the allocated care of address; and the first node informing the application of the care-of address.

Preferably the global home agent informs the first node of the allocated care-of address in response to a request from the first node.

The care-of address may be allocated to the mobile node using dynamic host configuration protocol.

The method may further comprise the steps of: registering the care of address with a regional home agent when the mobile node moves from the visited domain to a second visited domain; the regional home agent tunnelling received packets to the mobile node; and the mobile node tunnelling packets for the session to the first node via the regional home agent.

Preferably registering the allocated care of address with the global home agent includes an indication that the mobile node supports direct routing. Advantageously the global home agent informing the first node of the allocated care of address includes an indication that the mobile node supports direct routing.

The protocol constituting this embodiment of the invention is referred to in this description as “Mobile IP with direct routing”.

An embodiment of the invention will now be described, by way of example only, with reference to the accompanying drawings in which:

FIG. 1 shows routing of datagrams using Mobile IP between sub-networks connected via the Internet;

FIG. 2 shows routing of datagrams using Mobile IP with rout optimisation;

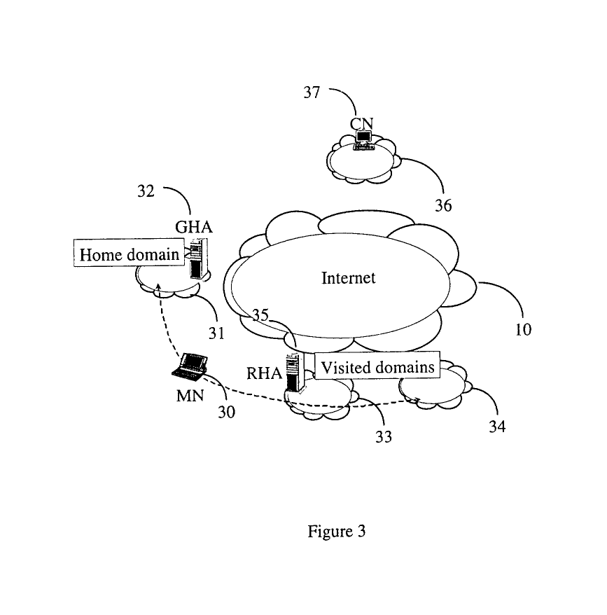

FIG. 3 shows a plurality of domains connected via the Internet;

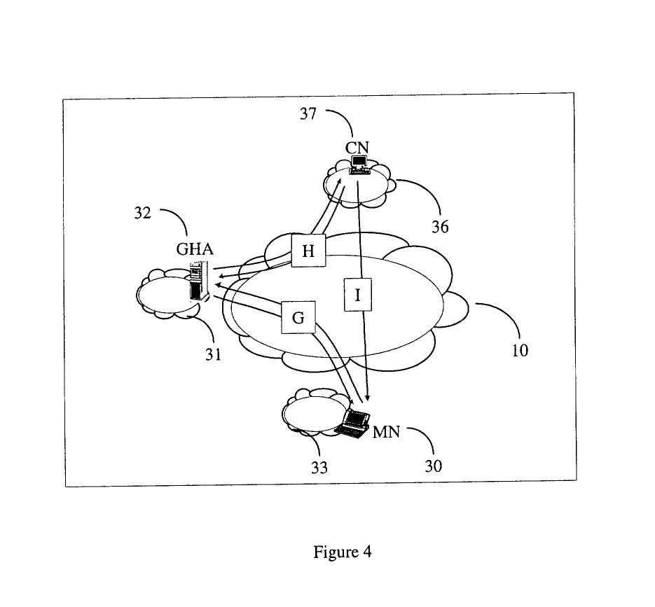

FIG. 4 shows routing of datagrams using Mobile IP with direct routing between domains via the Internet;

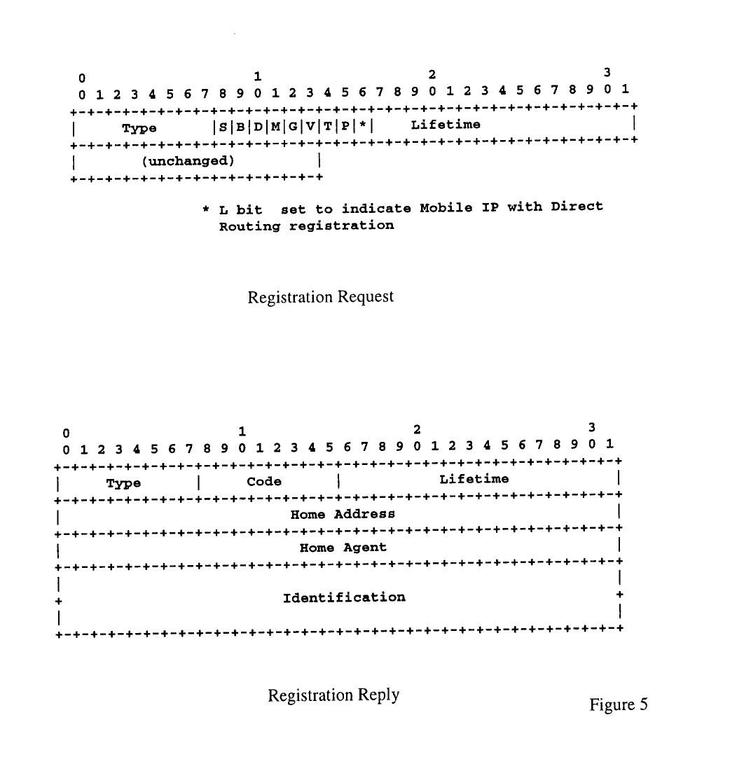

FIG. 5 shows the format of Registration Request and Registration Reply messages in Mobile IP with modification to support Mobile IP wth direct routing;

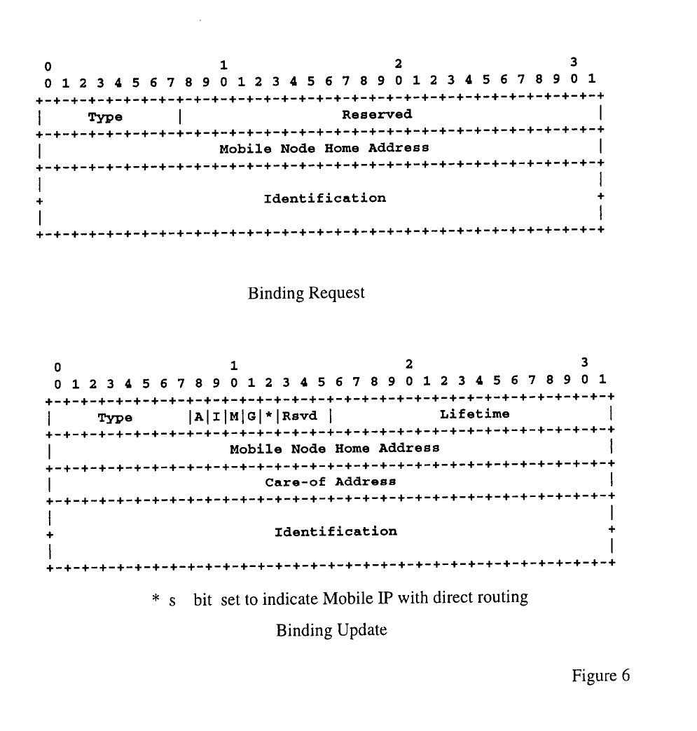

FIG. 6 shows Binding Request and Binding Update messages for Mobile IP with modification to support Mobile IP with direct routing;

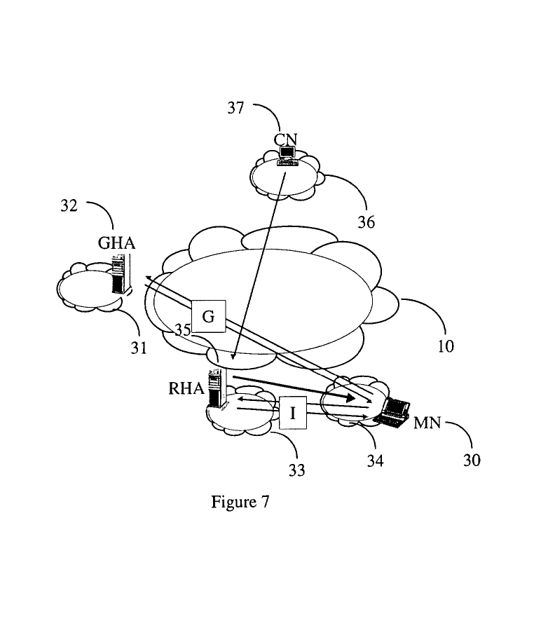

FIG. 7 shows datagrams using Mobile IP with direct routing between domains via the Internet after a mobile node has moved from one domain to another domain; and

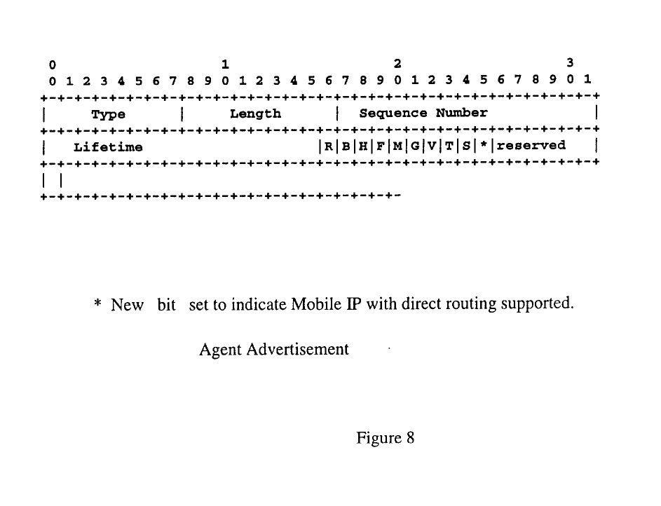

FIG. 8 shows the format of an Agent Advertisement message in Mobile IP with modification to support Mobile IP with direct routing.

In this description a domain is defined as a single network or set of (sub-)networks under a single administrative control. Within the domain (intra-domain) mobility support may be based as in Mobile IP, Mobile IP with route optimisation, Mobile IP with Regional Aware Foreign Agents (RAFA) (expired IETF draft from National University of Singapore), Hierarchical Mobile IP (draft-ietf-mobileip-reg-tunnel-02.txt) and other micro-mobility protocols (such as HAWAII, Cellular IP and EMA). (HAWAII: IETF draft work in progress, Cellular IP:draft-ietf-mobileip-cellularip-00.txt, EMA: draft-oneill-ema-01.txt) Any one of the mobility support protocols mentioned above can be used to deliver an IP datagram to the mobile node on the basis of the destination address for the datagram. If the mobile node is not reachable, for example, if it has moved to another domain, then the datagram is sent to (or intercepted by) a particular dedicated machine in the domain.

Referring to FIG. 3, a mobile node 30 is associated with a home domain 31 where a global home agent (GHA) 32 is located. It should be noted that the GHA can be a HA as described earlier with reference to Mobile IP or, indeed, it can be a directory/location database. In the latter case, it should be able to process the registration requests and replies and binding updates and replies. The home domain may be a logical concept only, i.e. the mobile node may never actually connect to the Internet 10 via the home domain 31. The global home agent performs a similar function to that of the home agent as described above with reference to Mobile IP. Other domains 33, 34 represent any domain other that the home domain. Each of the other domains 33, 34 (sometimes referred to as visited domains) has a mobility agent 35 known as a regional home agent (RHA) the function of which will be described later.

Referring now to FIG. 4, when the mobile node 30 is in its home domain 31, it has no need for mobility services. Routing is therefore performed by standard IP routing, together with any one of the mobility support protocols routing within the domain described earlier. When the mobile node 30 moves to another domain 33, it obtains a temporary care-of address in the visited domain 33. In this embodiment the address is a co-located care-of address which may be obtained by using an external assignment mechanism, for example DCHP as mentioned earlier. Alternatively, the address may be assigned by an access point. The access point can advertise it's services in a similar manner to the method used by the foreign agent in Mobile IP or Mobile IP with route optimisation. FIG. 8 shows a Mobile IP with route optimisation Agent Advertisement message, with an additional bit used to indicate that Mobile IP with direct routing is supported. The message shown in FIG. 8 is based on the modified mobility agent advertisement message as defined in the Mobile IP with route optimisation draft. The additional bit in this case is the first reserved bit.

The mobile node 30 then registers its new care-of address with its global home agent 32 by exchanging Registration Request and Registration Reply messages with it, as indicated by arrows G. This process is similar to that described earlier for Mobile IP. For Mobile IP with direct routing an additional bit in the registration request (which we will refer to as the ‘L’ bit) is set in the registration request message. FIG. 5 shows a possible message format of registration Request and registration reply. When the global home agent 32 receives a registration request with the ‘L’ bit set this means that the originating mobile node 30 supports direct routing. Therefore the global home agent 32 stores the fact that the mobile node 30 supports direct routing. The value of the care-of-address field in the Registration Request message is interpreted as being the current address allocated to the mobile node 30 for use whilst the mobile node 30 is in the visited domain 33. The format of the registration Reply message is the same as that defined in Mobile IP with route optimisation as shown in FIG. 5.

When a correspondent node (CN) 37 attached to a domain 36 is required by an application running on the node 37 to send a message intended for the mobile node 30 the correspondent node must first determine the address of node 30. The correspondent node performs DNS look up as described previously with reference to Mobile IP. However, before informing the application of the address to use for the session, the IP address thus obtained is used by the correspondent node 37 to send a binding request message. FIG. 6 shows the format of Binding Request and Binding Update messages as defined for Mobile IP. The Binding Request message is the same or Mobile IP with Direct Routing as for Mobile IP with Route optimisation (http://www.ietf.org/internet-drafts/draft-ietf-mobileip-optim-08.txt). If the mobile node 30 supports direct routing then the global home agent 40 will have stored this information during registration. The global home agent will send a Binding Update message (as shown in FIG. 6) to the correspondent node 37 with one of the (first) reserved bits (which we refer to as the ‘S’ bit) set. The exchange of Binding Request and Binding Update message is indicated by arrows H in FIG. 4. The correspondent node is than aware that the mobile node supports direct routing so it informs the application of the care-of address of the mobile node, which is then used to route IP datagrams directly to the mobile node 30, as indicated by arrow 1, for that session. Therefore there is no encapsulation or tunnelling required Mobile IP with direct routing is compatible with Mobile IP and with Mobile IP with route optimisatio at the minimal addition of two ‘bits’, namely the L and S bits

Referring now to FIG. 7, when the mobile node 30 moves to a new domain 34 the mobile node registers with both the global home agent 40 and the regional home agent (RHA) 35. Depending on the mobility support running in the old domain, the regional home agent can be the old Foreign Agent for Mobile IP with route optimastion or the RAFA if it is Mobile IP with RAFA and RHA if any one of the micro-mobility protocols are running in the old domain. Notification and registration with the RHA is not covered in this invention. In fact the mobile node must register with all previous regional home agents for which a session is still active. Registration Request messages utilising the ‘L’ bit, and Registration Reply messages are exchanged as depicted in FIG. 7 by arrows G and I. Datagrams which are sent directly to the mobile node 30 on the previously visited domain 33 will be intercepted by the regional home agent 35 and tunnelled to the mobile node 30. Therefore the regional home agent 35 is performing a similar role to that of the Home Agent described earlier with reference to Mobile IP. Clearly in this instance tunnelling and triangular routing are now occurring. However, the overhead is much less than in Mobile IP (and Mobile IP with route optimisation) because the distance from previously visited domain 33 and the current domain 34 is likely to be quite small, whereas the distance between the home domain 31 and the current domain 34 is potentially extremely great. Datagrams from the mobile node which are sent to the correspondent node 37 for sessions which were initiated whilst the mobile node was in a previous domain are tunnelled via the regional home agent 35 for the previous domain 33. However, the mobile node must store that co-located care of address which was active when each session was initiated in order to correctly encapsulate such datagrams. The mobile node 30 must also ensure that regular registration requests are sent to all regional home agents for which a session is active in order to maintain the registration, otherwise the registration will simply time-out as described previously.

If the correspondent node is required by another application to send data to the mobile node 30 then the correspondent node 37 will send another Binding Request message to the global home agent 40. On receipt of the Binding Update to reflect the new care-of address of the mobile node on the current domain 34 the correspondent node 37 must not delete the previously created binding cache entry if any sessions are still active. The new application will then send data directly to the mobile node.

1. A method of allocating a network address for an application to use during a session between a first node in a domain and a mobile node in a visited domain, said method comprising the steps of:
allocating a care-of address to the mobile node;
registering the allocated care-of address with a global home agent associated with the mobile node;
the global home agent informing the first node of the allocated care of address; and
the first node informing the application of the care-of address.

2. A method according to claim 1, in which the global home agent informs the first node of the allocated care-of address in response to a request from the first node.

3. A method according to claim 1 or claim 2 in which the care-of address is allocated to the mobile node using dynamic host configuration protocol.

4. A method according to any preceding claim, further comprising the steps of:
registering the care of address with a regional home agent when the mobile node moves from the visited domain to a second visited domain;
the regional home agent tunnelling received packets to the mobile node; and
the mobile node tunnelling packets for the session to the first node via the regional home agent.

5. A method according to any one of the preceding claims in which registering the allocated care of address with the global home agent includes an indication that the mobile node supports direct routing.

6. A method according to any one of the preceding claims in which the global home agent informing the first node of the allocated care of address includes an indication that the mobile node supports direct routing.
